(19) United States
(12) Patent Application Publication
(10) Pub. No.: US 2026/0095431 A1
(43) Pub. Date: Apr. 2, 2026

(54) Method and System for Automatic Retrieval of Relevant Data

(71) Applicant: RingCentral, Belmont, CA (US)

(72) Inventor: Vlad Vendrow, Reno, NV (US)

(73) Assignee: RingCentral, Inc., Belmont, CA (US)

(21) Appl. No.: 18/901,430

(22) Filed: Sep. 30, 2024

(51) Int. Cl. H04L 51/216; G06F 16/2457

(52) U.S. Cl. CPC H04L 51/216; G06F 16/24578

(57) ABSTRACT

The present disclosure provides a computer-implemented method for automatic data retrieval. The method comprises detecting an intent of a first user to initiate a communication with a second user; requesting the first user to provide a purpose of the communication; in response to receiving the purpose from the first user, analyzing records of prior communications between the first user and the second user; providing a subset of the records of prior communications concerning the purpose.

### TECHNICAL FIELD

The present disclosure relates generally to the field of computer-supported communications. More specifically, the present disclosure relates to systems and methods for automatic retrieval of data from prior communications between users.

### BACKGROUND

Audio and video calls have become indispensable in modern society and business operations. With the rise of remote work and global connectivity, these tools bridge geographical gaps, enabling real-time communication regardless of location. They offer a personal touch that emails or texts often lack, fostering stronger relationships among colleagues, clients, and partners. For businesses, audio and video calls enhance collaboration by allowing teams to meet virtually, share ideas, and solve problems efficiently. They eliminate the need for costly and time-consuming travel, making it easier to connect with global partners or remote employees. In a fast-paced business environment, quick decision-making is crucial, and the immediacy of a call facilitates this. Thus, audio and video calls have become essential tools that support the dynamic nature of modern communication, enabling businesses to flourish and individuals to stay connected in an increasingly digital world.

While effective communication is essential for both business and personal relationships, an overwhelming volume of communication can have negative effects. In business, constant communication often leads to information overload. Employees bombarded with emails, messages, and meetings can struggle to focus on their core tasks, leading to decreased productivity. The pressure to stay constantly connected can also result in stress and burnout, negatively impacting overall job performance and employee well-being.

The excessive volume of communications largely stems from the limitations of the human mind. Typically, this problem arises due to participants'poor memory or lack of records from previous interactions, leading to repetitive communication loops. While computer-supported communication has advanced significantly, it still lacks effective tools to help participants retain and recall the content discussed during calls.

### SUMMARY

The appended claims may serve as a summary of the invention.

### BRIEF DESCRIPTION OF THE DRAWINGS

FIG. 1 is a diagram of a collaboration system, according to an example embodiment of the present disclosure.

FIG. 2 is a diagram of a server, according to an example embodiment of the present disclosure.

FIG. 3 is a diagram of a user device, according to an example embodiment of the present disclosure.

FIG. 4 is an example GUI, according to an example embodiment of the present disclosure.

FIG. 5 is an example GUI, according to an example embodiment of the present disclosure.

FIG. 6 is an example ML architecture, according to an example embodiment of the present disclosure.

FIG. 7 is another example GUI, according to an example embodiment of the present disclosure.

FIG. 8 is another example GUI, according to an example embodiment of the present disclosure.

FIG. 9 is yet another example GUI, according to an example embodiment of the present disclosure.

FIG. 10 is a flowchart of a method for automatic data retrieval, according to an example embodiment of the present disclosure.

### DETAILED DESCRIPTION

Before various example embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (IOT) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

It should be understood, that terms “user” and “participant” have equal meaning in the following description.

Embodiments are described in sections according to the following outline:
1.0 GENERAL OVERVIEW
2.0 STRUCTURAL OVERVIEW
3.0 FUNCTIONAL OVERVIEW
4.0 PROCEDURAL OVERVIEW

### 1.0 General Overview

The current disclosure provides a technological solution to the technological problem of retrieving data from previous communications. Much of the information users seek through additional calls or messages often exists within the records of previous communication. This historical data can be a valuable resource for addressing user inquiries without the need for new communications. By providing proper access to this data, users become less inclined to initiate unnecessary communication to obtain it. This not only saves time for every user but also has significant technical benefits. Reducing the volume of new communications directly decreases server loads, which consequently mitigates overall delays, connection drops, and latency issues. This reduction in overall traffic allows servers to process requests more efficiently, leading to improved performance across the network infrastructure. As a result, users experience faster response times and more reliable connections. Additionally, the more efficient utilization of server resources means that existing hardware can handle a greater number of requests without becoming overwhelmed. This optimization not only enhances the user experience but also potentially reduces the need for frequent hardware upgrades or expansions. Furthermore, by minimizing unnecessary communication, this approach can contribute to energy savings and reduced operational costs.

The current solution solves these problems by providing an efficient solution for retrieving data from previous communications. In one aspect of the present disclosure, a computer-implemented method for automatic data retrieval is proposed. The method comprises the steps of: detecting an intent of a first user to initiate a communication with a second user; requesting the first user to provide a purpose of the communication; in response to receiving the purpose from the first user, analyzing records of prior communications between the first user and the second user; providing a subset of the records of prior communications concerning the purpose. Therefore, the current solution provides the technological benefit of automated retrieval of data from previous communications between users eliminating the need to make excessive communications between users.

In one embodiment of the present disclosure, the method further comprises detecting the intent of the first user to initiate the communication with the second user is based on a search request by a first user in a chat with the second user.

In another embodiment of the present disclosure, the analyzing the records of the prior communications further comprises, calculating, using a machine learning model, a matching score for each piece of the records of the prior communications with regard to the purpose.

In another embodiment of the present disclosure, the providing the piece of the records of the prior communications concerning the purpose further comprises providing the piece of the record with the highest matching score.

In another embodiment of the present disclosure, the providing the piece of the records of the prior communications concerning the purpose further comprises providing the pieces of the records with the matching score above a threshold.

In another embodiment of the present disclosure, the method further comprises in response to detecting that the matching score of pieces of the records of the prior communications is lower than the threshold, initiating the communication.

In yet another embodiment of the present disclosure, the intent includes inputting a phone number or selecting a contact in a contact list.

According to a second aspect of the present disclosure, a non-transitory, computer-readable medium is proposed. The medium stores a set of instructions that, when executed by a processor, cause the following: detecting an intent of a first user to initiate a communication with a second user; requesting the first user to provide a purpose of the communication; in response to receiving the purpose from the first user, analyzing records of prior communications between the first user and the second user; providing a piece of the records of prior communications concerning the purpose.

According to a third aspect of the present disclosure, a system connecting peripheral units to user devices is provided, the system comprises a processor; a memory operatively connected to the processor and storing instructions that, when executed by the processor, cause: detecting an intent of a first user to initiate a communication with a second user; requesting the first user to provide a purpose of the communication; in response to receiving the purpose from the first user, analyzing records of prior communications between the first user and the second user; providing a piece of the records of prior communications concerning the purpose.

### 2.0 Structural Overview

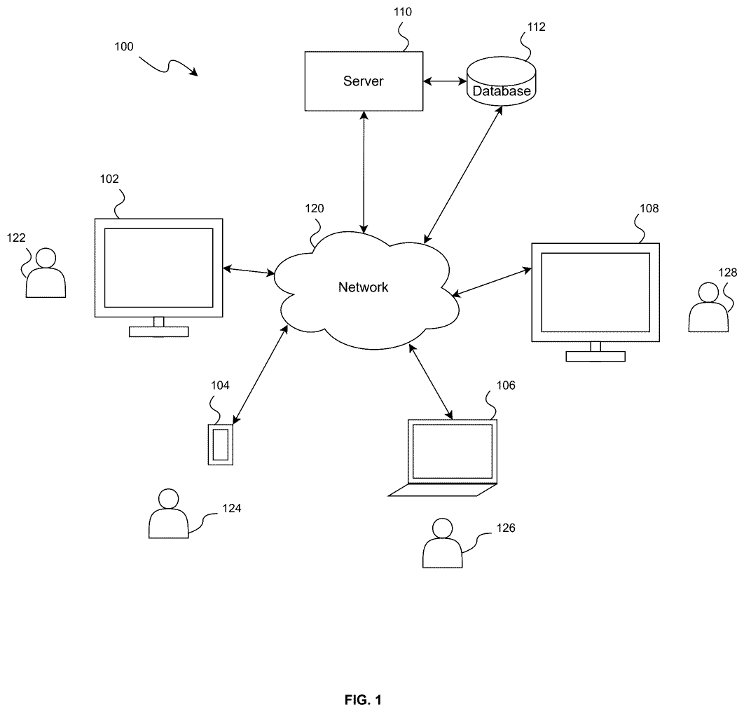

FIG. 1 shows a diagram of an example collaboration system suitable for realization of one of the embodiments of the current disclosure.

The collaboration system 100 facilitates communications between user devices 102, 104, 106, and 108 associated with corresponding users 122, 124, and 128 and a server 112. Network 120 may be any type of networks that provides communications or facilitates the exchange of information between the server 110, database 112, and user devices 102, 104, 106, and 108. For example, network 120 broadly represents a one or more local area networks (LANs), wide area networks (WANs), metropolitan area networks (MANs), global interconnected internetworks, such as the public internet, or other suitable connection(s) or combination thereof that enables collaboration system 100 to send and receive information between the user devices 102, 104, 106, and 108 and the server 110. Each such network 120 uses or executes stored programs that implement internetworking protocols according to standards such as the Open Systems Interconnect (OSI) multi-layer networking model, including but not limited to Transmission Control Protocol (TCP) or User Datagram Protocol (UDP), Internet Protocol (IP), Hypertext Transfer Protocol (HTTP), and so forth. All computers described herein are configured to connect to the network 120 and the disclosure presumes that all elements of FIG. 1 are communicatively coupled via network 120. A network may support a variety of electronic messaging formats, and may further support a variety of services and applications for user devices 102, 104, 106, and 108.

In particular, user devices 102, 104, 106, and 108 may be the desktop user devices 102, and 108 or smartphone devices, e.g., user device 104, executing any of known operational environment, e.g., Android OS or iOS. At the same time, other user devices 102, 104, 106, and 108 may be compact computing devices, such as laptop, e.g., user device 106, executing any of known operational environment, e.g., MS Windows, MacOS, Linux or Unix.

In accordance with the present disclosure, user devices 102, 104, 106, and 108 may exchange messages, participate in calls or video meetings, and share content with each other via network 120. In an embodiment, collaboration server 110 may also facilitate exchanging messages/calls and sharing content between users 122, 124, 126, and 128. For example, database 112 may store all messages exchanged between users, or store call records/transcripts carried oud between users. The server 110 may access the data stored in the database 112 via network 120.

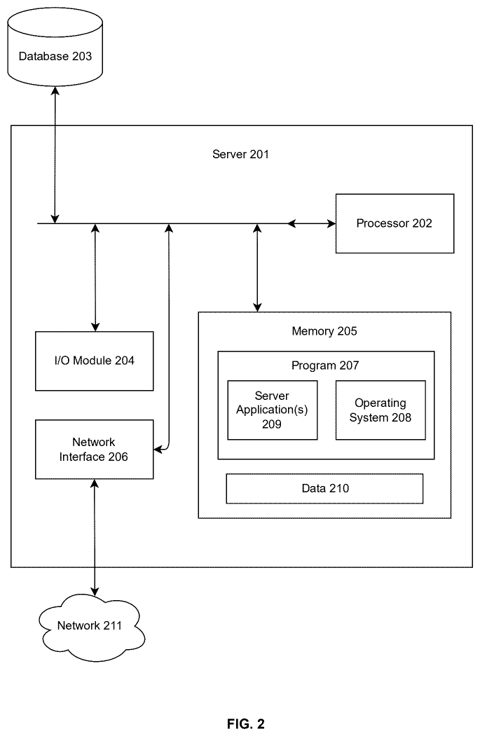

FIG. 2 is a block diagram that illustrates an example of a server 201 suitable for implementing the disclosed systems and methods. The server 201 may represent the collaboration server 110 of FIG. 1. The server 201 may include at least one processor, e.g., processor 202. The processor 202 may be operably connected to one or more databases (e.g., database 203), an input/output (I/O) module 204, memory 205, and network interface device 206.

I/O module 204 may be operably connected to a keyboard, mouse, touch screen controller, and/or other input controller(s) (not shown). Other input/control devices connected to I/O module 204 may include one or more touchpads, trackballs, buttons, rocker switches, thumbwheel, infrared port, USB port, and/or a pointer device such as a stylus.

Processor 202 may also be operably connected to memory 205. Memory 205 may include high-speed random-access memory and/or non-volatile memory, such as one or more magnetic disk storage devices, one or more optical storage devices, and/or flash memory (e.g., using NAND, NOR gates).

Memory 205 may include one or more programs 207. For example, memory 205 may store an operating system 208, such as DARWIN, RTXC, Linux®, iOS, Unix®, OS X, Windows®, or an embedded operating system such as VXWorks®. Operating system 208 may include instructions for handling basic system services and for performing hardware dependent tasks. In some implementations, operating system 208 may comprise a kernel (e.g., UNIX kernel).

Memory 205 may also store one or more server applications 209 to facilitate communicating with one or more additional devices, one or more computers and/or one or more servers. Server applications 209 may also include instructions to execute one or more of the disclosed methods.

Memory 205 may also store data 210. Data 210 may include transitory data used during instruction execution. Data 210 may also include data recorded for long-term storage.

Each of the above identified instructions and applications may correspond to a set of instructions for performing one or more functions described above. These instructions need not be implemented as separate software programs, procedures, or modules. Memory 205 may include additional instructions or fewer instructions. Furthermore, various functions of server 201 may be implemented in hardware and/or in software, including in one or more signal processing and/or application specific integrated circuits.

Communication functions may be facilitated through one or more network interfaces (e.g., network interface 206). Network interface 206 may be configured for communications over Ethernet, radio frequency, and/or optical (e.g., infrared) frequencies. The specific design and implementation of network interface 206 depends on the communication network(s) over which server 201 is intended to operate. For example, in some embodiments, server 201 includes wireless/wired network interface 206 designed to operate over a GSM network, a GPRS network, an EDGE network, a Wi-Fi® or WiMax® network, and a Bluetooth® network. In other embodiments, server 201 includes wireless/wired network interface 206 designed to operate over a TCP/IP network. Accordingly, network 211 (e. g, the network 120 of FIG. 1) may be any appropriate computer network compatible with network interface 206.

The various components in server 201 may be coupled by one or more communication buses or signal lines (not shown).

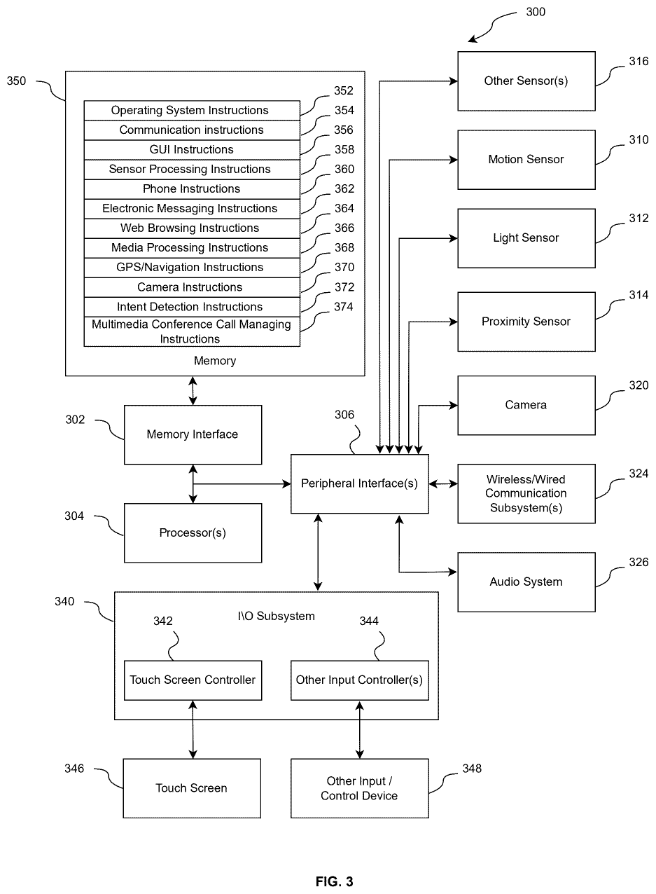

FIG. 3 is a diagram of an example of a user device 300 for use in a collaboration system, such as collaboration system 100. The user device 300 can be used to implement computer programs, applications, methods, processes, or other software to perform embodiments described in the present disclosure, such as the user devices 102, 104, 106, and 108. The user device 300 includes a memory interface 302, one or more processors 304 (which could be implemented as the processor 202 of the server 201) such as data processors, image processors and/or central processing units, and a peripherals interface 306. The memory interface 302, the one or more processors 304, and/or the peripherals interface 306 can be separate components or can be integrated in one or more integrated circuits. The various components in the user device 300 can be coupled by one or more communication buses or signal lines.

Sensors, devices, and subsystems can be coupled to the peripherals interface 306 to facilitate multiple functionalities. For example, a motion sensor 310, a light sensor 312, and a proximity sensor 314 can be coupled to the peripherals interface 206 to facilitate orientation, lighting, and proximity functions. Other sensors 316 can also be connected to the peripherals interface 306, such as a positioning system (e.g., GPS receiver), a temperature sensor, a biometric sensor, or other sensing device, to facilitate related functionalities. A GPS receiver can be integrated with, or connected to, the user device 300. For example, a GPS receiver can be built into mobile telephones, such as smartphone devices, e.g., user device 104, or into laptop, e.g., user device 106. GPS software allows mobile telephones to use an internal or external GPS receiver (e.g., connecting via a serial port or Bluetooth®). A camera subsystem 320 and an optical sensor 322, e.g., a charged coupled device (“CCD”) or a complementary metal-oxide semiconductor (“CMOS”) optical sensor, may be utilized to facilitate camera functions, such as recording photographs and video clips.

Communication functions may be facilitated through one or more wireless/wired communication subsystems 324, which includes an Ethernet port, radio frequency receivers and transmitters and/or optical (e.g., infrared) receivers and transmitters. The specific design and implementation of the wireless/wired communication subsystem 324 depends on the communication network(s) over which the user device 300 is intended to operate. For example, in some embodiments, the user device 300 includes wireless/wired communication subsystems 324 designed to operate over a GSM network, a GPRS network, an EDGE network, a Wi-Fi® or WiMax® network, and a Bluetooth® network. In an embodiment, the wireless/wired communication subsystem is used to communicate via a Bluetooth® connection with the wireless headset 200.

An audio subsystem 326 may be coupled to a speaker 328 and a microphone 330 to facilitate voice-enabled functions, such as voice recognition, voice replication, digital recording, and telephony functions.

The I/O subsystem 340 includes a touch screen controller 342 and/or other input controller(s) 344. The touch screen controller 342 is coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346. While a touch screen 346 is shown in FIG. 3, the I/O subsystem 340 may include a display screen (e.g., CRT or LCD) in place of the touch screen 346.

The other input controller(s) 344 is coupled to other input/control devices 348, such as one or more buttons, rocker switches, thumbwheel, infrared port, USB port, and/or a pointer device such as a stylus. The touch screen 346 can, for example, also be used to implement virtual or soft buttons and/or a keyboard.

The memory interface 302 is coupled to memory 350. The memory 350 includes high-speed random-access memory and/or non-volatile memory, such as one or more magnetic disk storage devices, one or more optical storage devices, and/or flash memory (e.g., NAND, NOR). The memory 350 stores an operating system 352, such as DRAWIN, RTXC, LINUX, iOS, UNIX, OS X, WINDOWS, or an embedded operating system such as VXWorkS. The operating system 352 can include instructions for handling basic system services and for performing hardware dependent tasks. In some implementations, the operating system 352 can be a kernel (e.g., UNIX kernel).

The memory 350 may also store communication instructions 354 to facilitate communicating with one or more additional devices, one or more computers and/or one or more servers. The memory 350 can include graphical user interface instructions 356 to facilitate graphic user interface processing; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GPS/navigation instructions 368 to facilitate GPS and navigation-related processes and instructions; camera instructions 370 to facilitate camera-related processes and functions; intent detection instructions 372 to facilitate detection of an intent of a user; and/or other software instructions to facilitate other processes and functions. The memory 350 may also include multimedia conference call managing instructions 374 to facilitate conference call related processes and instructions.

In some embodiments, the communication instructions 354 represent or include software applications to facilitate connection with the collaboration server 112 that connects plurality of user devices. The electronic messaging instructions 362 may include a software program to generate communication requests to the collaboration server 112 for carrying out communications. Further, the electronic messaging instructions 362 may include software applications to receive communication requests from the collaboration server 112. The graphical user interface instructions 356 may include a software program that facilitates display of the communication notifications to a user associated with the user device and facilitates the user to provide user input, and so on.

Each of the above-identified instructions and software applications may correspond to a set of instructions for performing one or more functions described above. These instructions may be implemented as separate software programs, procedures, or modules. The memory 350 may include additional instructions or fewer instructions. Furthermore, various functions of the user device 300 may be implemented in hardware and/or in software, including in one or more signal processing and/or application-specific integrated circuits.

The user device 300 of FIG. 3 or the user devices 102, 104, 106, and 108 of FIG. 1 may execute various applications stored in the memory 350. In one embodiment, the application may be a collaboration application or any other suitable client application for carrying out calls or participating in conferences.

In the presently described embodiment, the instructions cause the processor 304 to perform one or more functions of the disclosed methods. For example, phone instructions 360 may cause the wireless communication subsystem(s) 324 to connect to the server 201 or the other user device, e.g. user device 104, in order to perform a phone call. In some embodiments, GUI instructions 358 may cause the processors 304 to display a notification with the subset of the records of the previous communication. In particular embodiment, the intent detection instructions 372 may cause the processor 304 to detect an intent of the user and to initiate a communication with another user.

### 3.0 Functional Overview

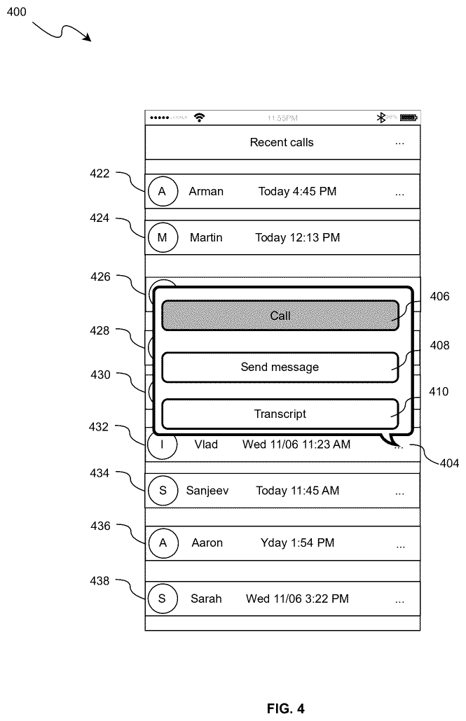

FIG. 4 depicts an example GUI 400 in accordance with the present disclosure. GUI 400 may be a part of the GUI displayed on a user device (such as user device 102-108 of FIG. 1 or the user device 300 of FIG. 3) and may represent a collaboration environment realized on a communication system (such as collaborating system 100 of FIG. 1). GUI 400 represents an example of how the processor 304 may detect an intent of the user to initiate a communication with another user using the intent detection instruction 372. In particular, GUI 400 represents a recent call window where the user is presented with the records of the recently performed calls (422-438). In this scenario, the user selected the record of the recent call 432 with contact Vlad performed on Wednesday November 6 at 11:23 AM. The interactions between the user and the GUI 400 may be performed using the touch screen controller 342. The processor 304 may process the data provided by the I/O subsystem 340 using the Sensor processing instructions 358. Once the user selects a three-dot control 404, the GUI 400 reveals a popup menu with three options: “Call” option 406, “Send message” option 408, and “Transcript” option 410. Upon selecting the “Call” option 406, the processor 304 may detect that the user wants to establish communication with user Vlad. At that moment, the processor may detect the user's intent to call Igor.

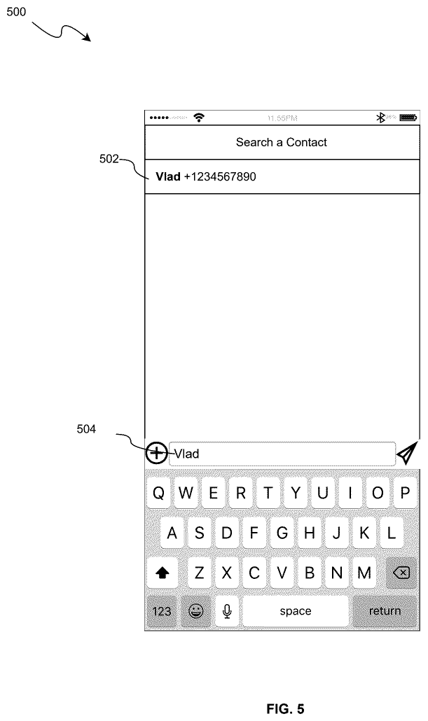

In another embodiment, the user intent may be detected based on the search performed by the user. The user intent may be detected when the user searches for a particular contact in the contact list by typing a number or name of a contact in a search field. FIG. 5 depicts an example GUI 500 in accordance with the present disclosure. GUI 500 may be a part of the GUI displayed on a user device (such as user device 102-108 of FIG. 1 or the user device 300 of FIG. 3) and may represent a collaboration environment realized on a communication system (such as collaborating system 100 of FIG. 1). GUI 500 represent an example of how the processor 304 may detect an intent of the user to initiate a communication with another user using the intent detection instruction 372. In particular, GUI 500 represents a contact search window where the user can search for a contact. In example, the user may type a search request 504—the name “Vlad” using the touch keyboard. In other embodiments, user may use other input/control devices 348. In response to the search request 504, the processor may find the particular contact 502 “Vlad+1234567890” matching the search criteria. If the processor 304 detects that the only contact matches the search criteria, this may be considered as the user's intent to initiate a call with another user, e.g., Vlad, in this example.

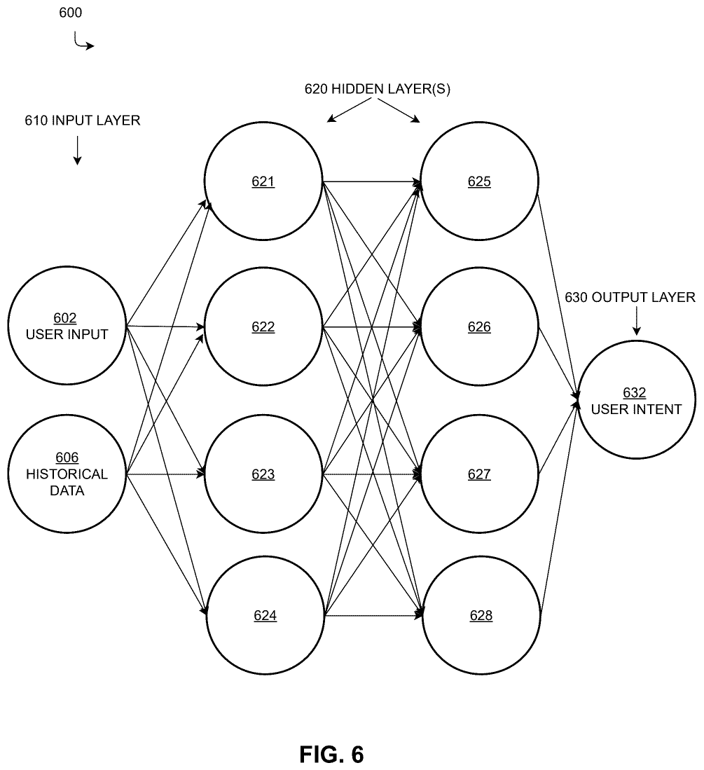

Alternatively, the processor 304 may detect the user intent using machine learning. Referring to FIG. 6, a neural network 600 may utilize an input layer 610, one or more hidden layers 620, and an output layer 630 to train a machine learning algorithm or model to detect user intent to initiate a communication with another user. In some embodiments, where the user intents are identified, supervised learning is used such that known input data, a weighted matrix, and know output data are used to gradually adjust the model to accurately compute the already known output. In other embodiments, where the user intents are not identified, unstructured learning is used such that a model attempts to reconstruct known input data over time, in order to learn.

Training of the neural network 600 using one or more training input matrices, a weight matrix and one or more known outputs may be initiated by one or more external computers associated with the collaboration environment. For example, the neural network 600 may be trained by one or more training computers and, once trained, used in association with the server 110 and/or user devices 102, 104, 106, or 108 to the intent of the user to initiate communication with another user. In an embodiment, a computing device may run known input data through a deep neural network 600 in an attempt to compute a particular known output. For example, a server computing device uses a first training input matrix and a default weight matrix to compute an output. If the output of the deep neural network does not match the corresponding known output of the first training input matrix, the server adjusts the weight matrix, such as by using stochastic gradient descent, to slowly adjust the weight matrix over time. The server then re-computes another output from the deep neural network with the input training matrix and the adjusted weight matrix. This process continues until the computer output matches the corresponding known output. The server then repeats this process for each training input dataset until a fully trained model is generated.

In the example of FIG. 6, the input layer 610 includes a plurality of training datasets that are stored as a plurality of training input matrices in an associated database, such as database 112 of FIG. 1. The training input data includes, for example, user input 602 and historical data 606. While the example of FIG. 6 uses a single neural network for both user input 602 and historical data 606, in some embodiments, one neural network 600 would be used to train a model for detecting an intent solely based on the user input, while another neural network 600 would be used to train a multimodal model for detecting the intent based on historical data. Any number of neural networks may be used to train the model.

In the embodiment of FIG. 6, hidden layers 620 represent various computational nodes 621, 622, 623, 624, 625, 626, 627, and 628. The lines between each of the nodes 621, 622, 623, 624, 625, 626, 627, and 628 represent weighted relationships based on the weight matrix. As discussed above, the weight of each line is adjusted over time as the model is trained. While the embodiment of FIG. 6 features two hidden layers 620, the number of hidden layers is not intended to be limiting. For example, one hidden layer, three hidden layers, ten hidden layers, or any other number of hidden layers may be used for a standard or deep neural network. The example of FIG. 6 also features an output layer 630 with the user intent 632 as the known output. The user intent 632 might be represented as a number indicating the percentage of the probability of the intent of the user to initiate a communication with another user. As discussed above, in this structured model, the user intent 632 is used as a target output for continuously adjusting the weighted relationships of the model. When the model successfully outputs user intent 632, then the model has been trained and may be used to process live or field data.

Once the model is trained by the neural network 600 of FIG. 6, the trained model will accept field data at the input layer 610, such as the history of the calls. In some embodiments, the field data is live data that is accumulated in real-time, e.g., user input while interacting with the user device. In other embodiments, the field data may be data that has been saved in an associated database, such as database 112. The trained model is applied to the field data to detect user intent at the output layer 630. For instance, a trained model can detect the user intent to establish a video call with another user based on the behavioral pattern where the user opens a chat with a second user and goes to the menu where the user has the option to make a video call to the second user.

In another example, the trained machine learning model may be used to identify the user intents based on behavioral patterns. The model may be trained on examples of the user behaviors indicating certain intents. For example, the train data may contain a subsequence of GUI interactions after which the user most likely will make a call. In a particular example, the user may try to find a time/date of the meeting with particular topic, but the search does not give a certain result or does not give any result. Right after that, the user may consider calling the second user in order to recall the time/date for the meeting. This behavioral pattern may be considered as the user intent.

It should be appreciated that the user intent is used here as a non-limiting term. The trained ML model may be used to identify the probability that the user will make a call/video call or start a conference session.

It should be appreciated that similar machine learning models could be used for other steps of the method according to the present disclosure. For example, other machine learning models could be trained to analyze the records of the prior communications between users in order to provide subsets of the recordings.

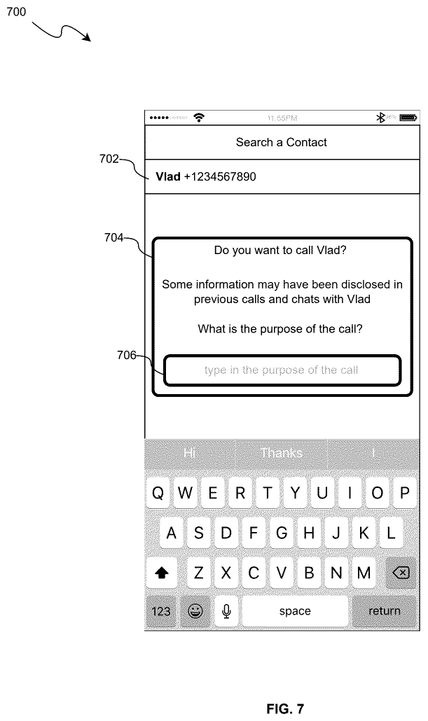

Referring now back to FIG. 5 and GUI 500, once the processor 304 detects the user intent to initiate a communication with the second user, the memory 350 may also store an instruction to cause the processor 304 to show a notification requesting the user to provide a purpose of the communication. FIG. 7 depicts an example GUI 700 in accordance with the present disclosure. GUI 700 may be a part of the GUI displayed on a user device (such as user device 102-108 of FIG. 1 or the user device 300 of FIG. 3) and may represent a collaboration environment realized on a communication system (such as collaborating system 100 of FIG. 1). GUI 700 represents an example of how the processor 304 may request the user to provide a purpose of the communication. In particular, GUI 700 illustrates the contact 702 “Vlad+1234567890” corresponding to the contact 504 found by matching the search criteria of FIG. 5. Additionally, GUI 700 illustrates a notification 704 presented to the user in response to detecting the user intent to call contact “Vlad+1234567890” in previous steps. The notification 704 lets the user know that some of the information the user is trying to get from the communication may have been disclosed in previous communications accessible by records, meaning that the call may be excessive. Further, the notification requests the user to provide the purpose of the call and allows the user to type in the purpose of the call into the type-in field 704.

In other embodiments, the purpose of the call may be requested in an Interactive Voice Response (IVR) format. For example, the processor 304 may initiate a session between a user device, such as user device 104, and the server 110 to request the purpose of the call. Alternatively, the IVR session may be performed locally using the processor 304 of the user device. In yet another embodiment, the request for the purpose may be performed in the form of chatbot interaction, where the bot may present a question to the user, on a user device 300, to provide the purpose of the call either textually or verbally. In the examples, where the request is requested solely by the processor 304 of the user device, the purpose of the communication may then be translated to the server 110 of the communication system for further processing.

Once the processor 304 receives the purpose of the call, the processor may analyze the content of the previous communications to identify a subset of the previous communications between the user of the user device and the second user (like Vlad in an example of the FIG. 7).

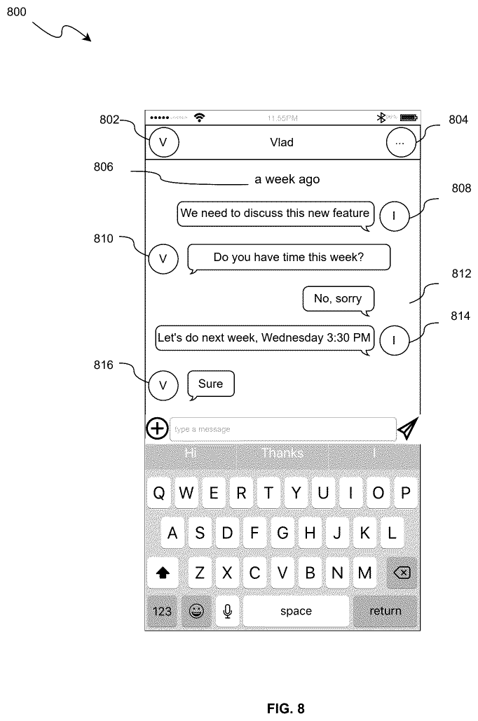

FIG. 8 depicts an example GUI 800 in accordance with the present disclosure. GUI 800 may be a part of the GUI displayed on a user device (such as user device 102-108 of FIG. 1 or the user device 300 of FIG. 3) and may represent a collaboration environment realized on a communication system (such as collaborating system 100 of FIG. 1). GUI 800 represents an example GUI for presenting previous communications. In particular, GUI 800 illustrates a chat window between the user of the user device and the second user. GUI 700 includes an indication 802 with whom the user exchanges messages, additional chat functions control 804, and a set of messages 808-816 exchanged by participants of the chat with the indication 806 when the messages were exchanged. In this particular example, it should be pointed out that the participants discussing a meeting about a “new feature” which will happen on “Wednesday, next week, at 3:30 PM”.

In the embodiment, the processor 304 gets access to the set of messages 808-816 to detect how each of the messages may cover the provided purpose of communication. In a particular embodiment, the processor 304 may search the text of the purpose provided by the user of the user device over the text of the messages to detect the subset of the messages that may correspond to the provided purpose. The purpose provided by the user may be “meeting on Wednesday”, the processor may provide a subset of the messages, e.g. the message 814 “Let's do next week, Wednesday 3:30 PM”.

In another embodiment, the processor 304 may identify a semantic meaning of the provided purpose and a semantic meaning of each of the messages. Then processor 304 may use the semantic meaning of the provided purpose to match it with the semantic meaning of each of the messages. In the result of such analysis the processor 304 may identify the message from the set of messages 808-816, that matches the provided purpose. In a particular example, the purpose provided by the user may be “meeting on Wednesday”, the processor may provide a subset of the messages, e.g. the messages 808 and 814.

In another embodiment, the analysis of the previous communications may be carried out using neural networks. A trained machine learning model could be used for identifying semantical correlation or matching score between the previous communications, e.g. chat messages, and the provided purpose. In a particular example, a neural network, like the neural network 600 of FIG. 6 may be used, where the subsets of the previous communications and the provided purpose are used as input for the neural network, and the matching score indicative of semantical correlation between the subsets and the provided purpose is the output. Based on the output of such ML model the processor 304 may provide the user with a subset of the records of the prior communications, e.g. particular messages from the chat. In other embodiments, the trained ML model may be a multimodal model capable of analyzing different types of content (e.g. text, pictures, audio, video) simultaneously. Based on the analysis of the records of the previous communications, the ML model may identify a matching score for each of the subsets of the records of the previous communications. In a particular embodiment, the ML model may identify the matching scores for each of the messages exchanged in the chat between users. As a result, there may be a list of the messages having high matching scores, e.g. 87%, 89%, 91%, and 92%. The Processor 304 may be instructed to provide only the messages with the highest matching score. In this example, the user may only see the message with a matching score of 92%. Alternatively, the processor 304 may be instructed to provide only the messages with a matching score above the predetermined threshold, e.g. more than 90%. In this example, the user may see the message with a matching score of 91% and 92%. In case all matching scores are below the predetermined threshold, the processor 304 may prompt the user to refine the search. In case there are more than the predetermined number (e.g. 10) of the messages with a matching score above the threshold, the processor 304 may also prompt the user to refine the search.

It should be appreciated that the example where the processor 304 of the user device 300 executes all these instructions is not meant to be limiting. These instructions could also be executed by the processor 202 of the server 201 or other processors of other devices of the collaborating system 100 of FIG. 1.

It also should be appreciated that the previous communication may be any of the previous audio calls, video calls, virtual conferences or meetings, messages exchanged within the collaborative environment, or separate messaging systems, like WhatsApp, Viber, or Telegram. Previous communications may also include content shared within messages, e.g. pictures, links, video files, audio files, 3D models, and VR content. Previous communication may also include the content of the shared screen during the video meeting or the virtual conference. At the same time, the records of the previous communications may include audio recordings of the call, video recordings of the video call, virtual meeting, or virtual conferences. The records may also include a transcript of the audio or video recording. The records may also include messages exchanged within the chat or the content shared in the chat. The records may also include separate video recordings of screenshots of the shared screen of video calls or virtual conferences.

As discussed above with reference to FIG. 8, the subset of the recording of the previous communication may be a distinct message of the chat between the participants. The subset may also include a short audio/video snippet of the audio/video call or the virtual conference. The subset may also include part of the transcript of the audio/video call. The subset may include a screenshot/picture of the video recording or the shared screen of the video meeting or the virtual conference. The subset may include attachments shared in private chats or a chat of conference.

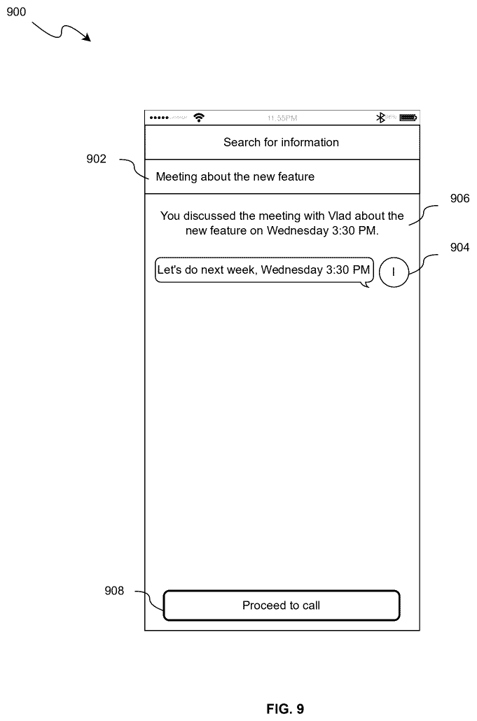

Once the processor 304 identifies the subset of the record of the previous communication concerning the purpose, the processor 304 may provide this subset to the user. FIG. 9 depicts an example GUI 900 in accordance with the present disclosure. GUI 900 may be a part of the GUI displayed on a user device (such as user device 102-108 of FIG. 1 or the user device 300 of FIG. 3) and may represent a collaboration environment realized on a communication system (such as collaborating system 100 of FIG. 1). GUI 900 represents an example of how the identified subset may be provided to the user. In particular, GUI 900 includes the provided purpose 902 “Meeting about the new feature” which may be provided by the user in previous steps. Then GUI 900 includes the subset of the recording of the previous communication-message 904 “Let's do next week, Wednesday 3:30 PM”. Additionally, the GUI 900 may have a little summary 906 of the record of the previous communication, indicating where and when the provided message 904 was posted.

Furthermore, GUI 900 may include a “Proceed to Call” control 908, upon selecting which the processor 304 may establish the indented communication. In case when the processor did not find/identify any subset of previous communication, the user may also be provided with the “Proceed to Call” control 908, so that the user may make the call anyway. Alternatively, in the case when the analysis of the records of the previous communications did not give any result, processor 304 may automatically initiate the intended communication.

In other embodiment, in the case when the analysis of the records of the previous communications did not give any result or give too many plausible results, the processor 304 may prompt the user with another GUI notification to refine the search.

### 4.0 Procedural Overview

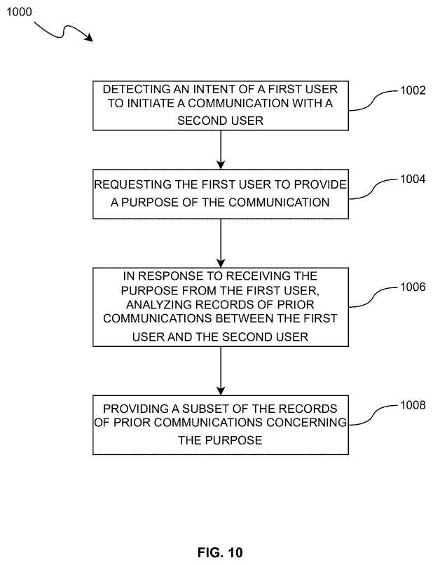

FIG. 10 shows a flowchart of an example method 1000 for automatic retrieval of data. Method 1000 may be implemented using a general-purpose computer including a processor, e.g., server 201 of FIG. 2 or user device 300 of FIG. 3. Alternatively, a special-purpose computer may be built for implementing method 1000 using suitable logic elements.

At step 1002, the processor detects an intent of a first user to initiate a communication with a second user. The processor may represent processor 304 of the user device 300 of FIG. 3 or the processor 202 of the server 201 of FIG. 4. In both cases, the processors receive signals indicating that the user of the user device 300 has an intent to establish a communication session with another user. In an embodiment, the processor 304 of the user device 300 may detect the intent of the user. Additionally, the processor 304 may communicate the intent to the processor 202 of the server 201. Alternatively, the processor 304 of the user device 300 may communicate some or all user interactions with the user device 300 to the processor 202 of the server, the processor 202 of the server 201 then may detect the intent of the user. In the other embodiment, the processor 202 may receive the signals from other servers or from other user devices.

At step 1004, the processor requests the first user to provide a purpose of the communication. At this step, the processor 304 of the user device may request the user of the user device 300 to provide the purpose of the communication by showing GUI notification for the user. Alternatively, the processor 202 of the server 201 may communicate a notification to the user device 300 and cause the processor 304 to show the notification to the user. In response to receiving the notification, the user of the user device 300 may provide a purpose of the communication the user intended to initiate. For example, the user may type in, using touch screen 346 of the user device 300, the purpose of the call, e.g. “What was the topic we discussed with Marin yesterday evening?”.

At step 1006, the processor analyzes records of prior communications between the first user and the second user, in response to receiving the purpose from the first user. At this step, the processor 304 of the user device 300 compares the records of the prior communications between the user of the user device and the second user with the purpose received on the step 1004. In other embodiment, the provided purpose may be communicated to the server 201, and the processor 202 may perform such analysis. As the result of the analysis the processors may select the subset of the records of the previous communications between users. In a particular embodiment, the processor may identify a snippet of the video record of the virtual conference with multiple participants that happened yesterday, where the user of the user device 300 discusses a certain topic with the other participant “Martin” of the virtual conference.

At step 1008, the processor provides a subset of the records of prior communications concerning the purpose. At this step, the processor 304 of the user device 300 may cause to show a notification with the result of the analysis. In another embodiment, the processor 204 may provide the subset of the records in different formats. For example, the processor 304 may use text-to-speech to provide the subsets of text, play the subsets of audio records, use speech-to-text on the audio records to provide text, or provide video snippets of the records.

What is claimed is:

1. A computer-implemented method for automatic data retrieval comprising:
detecting an intent of a first user to initiate a communication with a second user;
requesting the first user to provide a purpose of the communication;
in response to receiving the purpose from the first user, analyzing records of prior communications between the first user and the second user;
providing a subset of the records of prior communications concerning the purpose.

2. The computer-implemented method of claim 1, wherein detecting the intent of the first user to initiate the communication with the second user is based on a search request by a first user in a chat with the second user.

3. The computer-implemented method of claim 1, wherein the analyzing the records of the prior communications further comprises: calculating, using a machine learning model, a matching score for each subset of the records of the prior communications with regard to the purpose.

4. The computer-implemented method of claim 3, wherein the providing the subset of the records of the prior communications concerning the purpose further comprises providing the subset of the record with the highest matching score.

5. The computer-implemented method of claim 3, wherein the providing the subset of the records of the prior communications concerning the purpose further comprises providing the subsets of the records with the matching score above a threshold.

6. The computer-implemented method of claim 5, wherein the method further comprising:
in response to detecting that the matching score of subsets of the records of the prior communications is lower than the threshold, initiating the communication.

7. The computer-implemented method of claim 1, wherein the intent includes inputting a phone number or selecting a contact in a contact list.

8. A non-transitory, computer-readable medium storing a set of instructions that, when executed by a processor, cause:
detecting an intent of a first user to initiate a communication with a second user;
requesting the first user to provide a purpose of the communication;
in response to receiving the purpose from the first user, analyzing records of prior communications between the first user and the second user;
providing a subset of the records of prior communications concerning the purpose.

9. The non-transitory, computer-readable medium of claim 8, wherein detecting the intent of the first user to initiate the communication with the second user is based on a search request by a first user in a chat with the second user.

10. The non-transitory, computer-readable medium of claim 8, wherein the analyzing the records of the prior communications further comprises: calculating, using a machine learning model, a matching score for each subset of the records of the prior communications with regard to the purpose.

11. The non-transitory, computer-readable medium of claim 10, wherein the providing the subset of the records of the prior communications concerning the purpose further comprises providing the subset of the record with the highest matching score.

12. The non-transitory, computer-readable medium of claim 10, wherein the providing the subset of the records of the prior communications concerning the purpose further comprises providing the subsets of the records with the matching score above a threshold.

13. The non-transitory, computer-readable medium of claim 12, wherein the set of instructions further comprises:
in response to detecting that the matching score of subsets of the records of the prior communications is lower than the threshold, initiating the communication.

14. The non-transitory, computer-readable medium of claim 8, wherein the intent includes inputting a phone number or selecting a contact in a contact list.

15. A system for automatic data retrieval, the system comprising:
a processor;
a memory operatively connected to the processor and storing a set of instructions that, when executed by the processor, cause:
detecting an intent of a first user to initiate a communication with a second user;
requesting the first user to provide a purpose of the communication;
in response to receiving the purpose from the first user, analyzing records of prior communications between the first user and the second user;
providing a subset of the records of prior communications concerning the purpose.

16. The system of claim 14, wherein detecting the intent of the first user to initiate the communication with the second user is based on a search request by a first user in a chat with the second user.

17. The system of claim 14, wherein the analyzing the records of the prior communications further comprises: calculating, using a machine learning model, a matching score for each subset of the records of the prior communications with regard to the purpose.

18. The system of claim 17, wherein the providing the subset of the records of the prior communications concerning the purpose further comprises providing the subset of the record with the highest matching score.

19. The system of claim 17, wherein the providing the subset of the records of the prior communications concerning the purpose further comprises providing the subsets of the records with the matching score above a threshold.

20. The system of claim 17, wherein the set of instructions further comprises:
in response to detecting that the matching score of subsets of the records of the prior communications is lower than the threshold, initiating the communication.
